(19) United States
(12) Patent Application Publication
(10) Pub. No.: US 2026/0371424 A1
(43) Pub. Date: Nov. 19, 2026

(54) SHARING ACCESS POINT, SHARED ACCESS POINT, AND COMMUNICATION METHOD THEREOF

(71) Applicant: NTT, Inc., Tokyo (JP)

(72) Inventors: Akira KISHIDA, Tokyo (JP); Kengo NAGATA, Tokyo (JP); Hirantha ABEYSEKERA, Tokyo (JP); Hanae OTANI, Tokyo (JP); Yusuke ASAI, Tokyo (JP); Yasushi TAKATORI, Tokyo (JP)

(73) Assignee: NTT, Inc., Tokyo (JP)

(21) Appl. No.: 19/486,977

(22) PCT Filed: Jun. 1, 2023
(86) PCT No.: PCT/JP2023/020521

§ 371 Date: Nov. 24, 2025

(51) Int. Cl. H04W 76/15; H04L 5/00

(52) U.S. Cl. CPC H04W 76/15; H04L 5/0048

(57) ABSTRACT

A communication system includes a sharing access point and a shared access point. The sharing access point includes a first management unit and a first wireless signal processing unit. The shared access point includes a second management unit and a second wireless signal processing unit. The first management unit generates first information regarding a plurality of wireless signal processing units including the second wireless signal processing unit, and causes at least one of the first wireless signal processing unit or the second wireless signal processing unit to report the first information.

### TECHNICAL FIELD

An embodiment relates to a sharing access point, a shared access point, and a communication method thereof.

### BACKGROUND ART

A multi-link transmission method by a wireless local area network (LAN) is known as a communication system that wirelessly connects an access point (AP) and a terminal. In a multi-link transmission method, data exchange between a multi-link device in an access point (AP multi-link device (MLD)) and a multi-link device in a terminal (non-AP MLD) is implemented by wireless links between a plurality of affiliated APs in the access point and a plurality of affiliated STAs in the terminal.

### CITATION LIST

### Non Patent Literature

Non Patent Literature 1: IEEE802.11be D3.0, “35.3 Multi-link operation”, p 479-p 586, January 2023

### SUMMARY OF INVENTION

### Technical Problem

However, in the multi-link transmission method, the terminal cannot use wireless links with a plurality of affiliated APs that belongs to different AP MLDs in combination.

On the other hand, from the viewpoint of improving a wireless communication environment, it is desirable that the terminal can use wireless links with a plurality of affiliated APs included in a plurality of access points in combination.

The present invention has been made in view of the above circumstances, and an object of the present invention is to provide an access point that improves a wireless communication environment.

### Solution to Problem

A sharing access point of one aspect is a sharing access point in a communication system including a sharing access point and a shared access point. The sharing access point includes a first management unit and a first wireless signal processing unit. The shared access point includes a second management unit and a second wireless signal processing unit. The first management unit generates first information regarding a plurality of wireless signal processing units including the second wireless signal processing unit, and causes at least one of the first wireless signal processing unit or the second wireless signal processing unit to report the first information.

### Advantageous Effects of Invention

According to an embodiment, an access point and a terminal device that improve a wireless communication environment can be provided.

### BRIEF DESCRIPTION OF DRAWINGS

FIG. 1 is a block diagram illustrating a configuration of a communication system according to an embodiment.

FIG. 2 is a block diagram illustrating an example of a hardware configuration of a sharing AP according to the embodiment.

FIG. 3 is a block diagram illustrating an example of a hardware configuration of a shared AP according to the embodiment.

FIG. 4 is a block diagram illustrating an example of a hardware configuration of a terminal according to the embodiment.

FIG. 5 is a block diagram illustrating an example of a functional configuration of the sharing AP according to the embodiment.

FIG. 6 is a table illustrating an example of a data structure of multi-link management information stored in the sharing AP according to the embodiment.

FIG. 7 is a table illustrating an example of a data structure of terminal connection information stored in the sharing AP according to the embodiment.

FIG. 8 is a block diagram illustrating an example of a functional configuration of the shared AP according to the embodiment.

FIG. 9 is a table illustrating an example of a data structure of multi-link management information stored in the shared AP according to the embodiment.

FIG. 10 is a table illustrating an example of a data structure of link management information stored in the shared AP according to the embodiment.

FIG. 11 is a block diagram illustrating an example of a functional configuration of the terminal according to the embodiment.

FIG. 12 is a table illustrating an example of a data structure of the link management information stored in the terminal according to the embodiment.

FIG. 13 is a sequence diagram illustrating an example of a series of processing including pseudo multi-link connection processing in the communication system according to the embodiment.

### DESCRIPTION OF EMBODIMENTS

Hereinafter, embodiments will be described with reference to the drawings. Note that in the following description, components including the same function and configuration are denoted by the same reference signs.

### 1. Embodiment

### 1.1 Configuration

### 1.1.1 Communication System

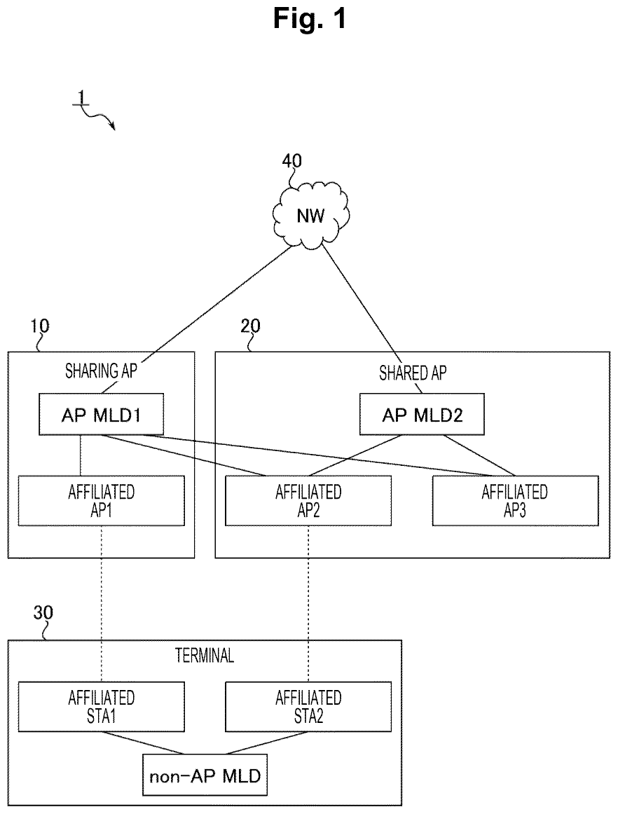

FIG. 1 is a block diagram illustrating an example of a configuration of a communication system according to an embodiment. As illustrated in FIG. 1, a communication system 1 includes a sharing AP 10, a shared AP 20, a terminal 30, and a network 40.

The sharing AP 10, the shared AP 20, and the terminal 30 include, for example, a wireless communication function based on an open systems interconnection (OSI) reference model. In the OSI reference model, the wireless communication function is divided into seven layers (first layer: physical layer, second layer: data link layer, third layer: network layer, fourth layer: transport layer, fifth layer: session layer, sixth layer: presentation layer, seventh layer: application layer). The data link layer includes a logical link control (LLC) sublayer and a media access control (MAC) sublayer.

Specifically, for example, the sharing AP 10 and the shared AP 20 operate as a single access point. The sharing AP 10 includes an AP MLD1 and an affiliated AP1. The shared AP 20 includes an AP MLD2, an affiliated AP2, and an affiliated AP3.

Each of the AP MLD1 and the AP MLD2 is a multi-link device (MLD), and is an entity that establishes logical wireless connection with the terminal 30. That is, the AP MLD1 and the AP MLD2 can be a terminal on the sharing AP 10 side and a terminal on the shared AP 20 side in data exchange with the terminal 30 in wireless communication, respectively. Each of the AP MLD1 and the AP MLD2 communicates with a server (not illustrated) on the network 40 in a wired or wireless manner. The AP MLD1 communicates with the affiliated AP1, the affiliated AP2, and the affiliated AP3 in a wired manner. The AP MLD2 communicates with the affiliated AP2 and the affiliated AP3 in a wired manner.

Each of the affiliated AP1, the affiliated AP2, and the affiliated AP3 is an entity that physically and wirelessly connects with the terminal 30. That is, each of the affiliated AP1, the affiliated AP2, and the affiliated AP3 includes a physical configuration in which data is exchanged by a wireless link with the terminal 30. The affiliated AP1 belongs to the AP MLD1. Each of the affiliated AP2 and the affiliated AP3 may belong to either the AP MLD1 or the AP MLD2. Here, “the affiliated AP belongs to the AP MLD” means that the affiliated AP can be used for data exchange between the AP MLD and the terminal.

The affiliated AP1, the affiliated AP2, and the affiliated AP3 include configurations equivalent to each other. Hereinafter, in a case where the affiliated AP1, the affiliated AP2, and the affiliated AP3 are not particularly distinguished, they may be described as an affiliated AP.

The terminal 30 is, for example, a smartphone, a personal computer (PC), or the like, and is a wireless terminal device compatible with the multi-link transmission method compliant with the IEEE802.11 standard. The terminal 30 includes a non-AP MLD, and an affiliated STA1 and an affiliated STA2.

The non-AP MLD is a multi-link device in the terminal 30, and is an entity that establishes logical wireless connection with the sharing AP 10. That is, the non-AP MLD can be a terminal on the terminal 30 side in data exchange in wireless communication with each of the sharing AP 10 and the shared AP 20. The non-AP MLD is connected to the affiliated STAI and the affiliated STA2 via a wire.

Each of the affiliated STAI and the affiliated STA2 is an entity that physically wirelessly connects with the affiliated AP. That is, each of the affiliated STAI and the affiliated STA2 includes a physical configuration in which data is exchanged by a wireless link with the affiliated AP. Each of the affiliated STAL and the affiliated STA2 belongs to the non-AP MLD. Here, “the affiliated STA belongs to the non-AP MLD” means that the affiliated STA can be used for data exchange between the non-AP MLD and the AP MLD.

Note that the affiliated STA1 and the affiliated STA2 include configurations equivalent to each other, Hereinafter, in a case where the affiliated STA1 and the affiliated STA2 are not particularly distinguished, they may be described as an affiliated STA.

In the present embodiment, the AP MLD and the non-AP MLD exchange data by a plurality of wireless links between a plurality of affiliated APs included in different access points and a plurality of affiliated STAs included in the same terminal 30. The transmission method according to the present embodiment is different from a normal multi-link transmission method in which data is exchanged by a plurality of wireless links between a plurality of affiliated APs included in the same access point and a plurality of affiliated STAs included in the same terminal 30. In the transmission method according to the present embodiment, the AP MLD performs data exchange while being conscious of which access point an affiliated AP that establishes a wireless link is included. On the other hand, the non-AP MLD performs data exchange using a scheme of the multi-link transmission method without being conscious of which access point an affiliated AP that establishes a wireless link is included. Therefore, the transmission method according to the present embodiment can be said to be a multi-link transmission method from the viewpoint of the non-AP MLD, but can also be said to be a pseudo multi-link transmission method from the viewpoint of the AP MLD. The pseudo multi-link transmission method may be read as a multi-AP transmission method.

The example of FIG. 1 illustrates a case where the AP MLD1 and the non-AP MLD exchange data using a wireless link between the affiliated AP1 and the affiliated STA1 and a wireless link between the affiliated AP2 and the affiliated STA2.

### 1.1.2. Hardware Configuration

Next, hardware configurations of the sharing AP, the shared AP, and the terminal in the communication system according to the embodiment will be described.

### 1.1.2.1 Hardware Configuration of Sharing AP

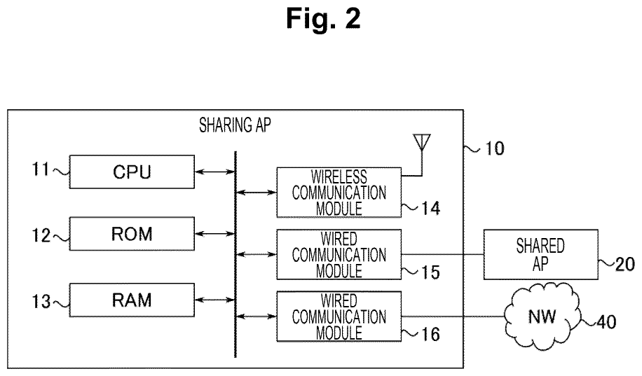

FIG. 2 is a block diagram illustrating an example of a hardware configuration of the sharing AP according to the embodiment. As illustrated in FIG. 2, the sharing AP 10 includes, for example, a central processing unit (CPU) 11, a read only memory (ROM) 12, a random access memory (RAM) 13, a wireless communication module 14, a wired communication module 15, and a wired communication module 16.

The CPU 11 is a processing circuit that controls the entire operation of the sharing AP 10. The ROM 12 is a nonvolatile semiconductor memory, for example. The ROM 12 stores a program for controlling the sharing AP 10, and data. The RAM 13 is, for example, a volatile semiconductor memory. The RAM 13 is used as a working area of the CPU 11. The wireless communication module 14 is a circuit used to transmit and receive data with a wireless signal. The wireless communication module 14 is connected to an antenna. The wired communication modules 15 and 16 are circuits used to transmit and receive data by a wired signal. The wired communication module 15 is connected to the shared AP 20. The wired communication module 16 is connected to the network 40.

### 1.1.2.2 Hardware Configuration of Shared AP

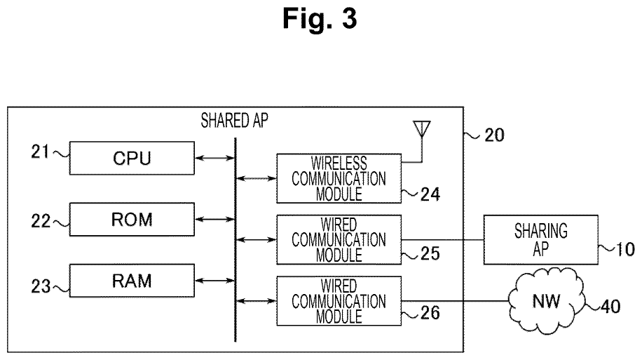

FIG. 3 is a block diagram illustrating an example of a hardware configuration of the shared AP according to the embodiment. As illustrated in FIG. 3, the shared AP 20 includes, for example, a CPU 21, a ROM 22, a RAM 23, a wireless communication module 24, a wired communication module 25, and a wired communication module 26.

The CPU 21 is a processing circuit that controls the entire operation of the shared AP 20. The ROM 22 is a nonvolatile semiconductor memory, for example. The ROM 22 stores a program for controlling the shared AP 20, and data. The RAM 23 is, for example, a volatile semiconductor memory. The RAM 23 is used as a working area of the CPU 21. The wireless communication module 24 is a circuit used to transmit and receive data with a wireless signal. The wireless communication module 24 is connected with an antenna. The wired communication modules 25 and 26 are circuits used to transmit and receive data by a wired signal. The wired communication module 25 is connected to the sharing AP 10. The wired communication module 26 is connected to the network 40.

### 1.1.2.3 Hardware Configuration of Terminal

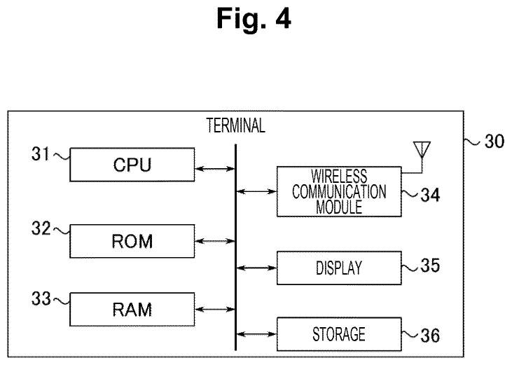

FIG. 4 is a block diagram illustrating an example of a hardware configuration of the terminal according to the embodiment. As illustrated in FIG. 4, the terminal 30 includes, for example, a CPU 31, a ROM 32, a RAM 33, a wireless communication module 34, a display 35, and a storage 36.

The CPU 31 is a processing circuit that controls the entire operation of the terminal 30. The ROM 32 is a nonvolatile semiconductor memory, for example. The ROM 32 stores a program for controlling the terminal 30, and data. The RAM 33 is, for example, a volatile semiconductor memory. The RAM 33 is used as a working area of the CPU 31. The wireless communication module 34 is a circuit used to transmit and receive data by a wireless signal. The wireless communication module 34 is connected with an antenna. The display 35 is, for example, a liquid crystal display (LCD) or an electro luminescence (EL) display. The display 35 displays a graphical user interface (GUI) corresponding to application software, or the like. The storage 36 is a nonvolatile storage device. The storage 36 stores system software of the terminal 30, and the like.

### 1.1.3 Functional Configuration

Next, functional configurations of the access point and the terminal in the communication system according to the embodiment will be described.

### 1.1.3.1 Functional Configuration of Sharing AP

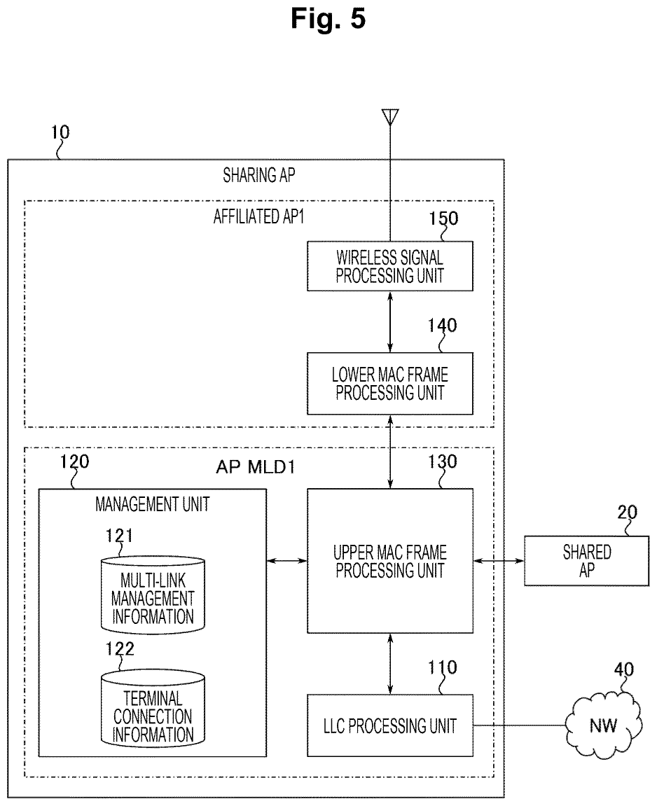

FIG. 5 is a block diagram illustrating an example of a functional configuration of the sharing AP according to the embodiment.

The sharing AP 10 functions as a computer including an LLC processing unit 110, a management unit 120, an upper MAC frame processing unit 130, a lower MAC frame processing unit 140, and a wireless signal processing unit 150. The LLC processing unit 110 is a functional block that executes processing corresponding to the LLC sublayer of the second layer and the third layer to the seventh layer. The management unit 120, the upper MAC frame processing unit 130, and the lower MAC frame processing unit 140 are functional blocks that execute processing corresponding to the MAC sublayer of the second layer. The wireless signal processing unit 150 is a functional block that executes processing corresponding to the first layer. The LLC processing unit 110, the management unit 120, and the upper MAC frame processing unit 130 function as, for example, the AP MLD1. The lower MAC frame processing unit 140 and the wireless signal processing unit 150 function as, for example, the affiliated AP1.

The LLC processing unit 110 adds, for example, a destination service access point (DSAP) header, a source service access point (SSAP) header, and the like to data received from the network 40, and inputs the data to the upper MAC frame processing unit 130. Furthermore, the LLC processing unit 110 transmits data input from the upper MAC frame processing unit 130 to the network 40.

The management unit 120 controls logical wireless connection between the AP MLD1 and the non-AP MLD in the pseudo multi-link transmission method. For example, the management unit 120 executes pseudo multi-link connection processing in response to a multi-link connection request from the terminal 30. Furthermore, the management unit 120 stores multi-link management information 121 and terminal connection information 122.

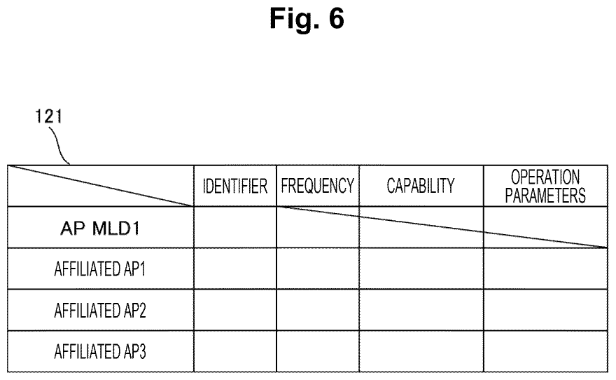

FIG. 6 is a table illustrating an example of a data structure of the multi-link management information stored in the sharing AP according to the embodiment.

As illustrated in FIG. 6, information provided to the terminal 30 in a case where the pseudo multi-link transmission method is used is stored in the multi-link management information 121. Specifically, the multi-link management information 121 stores information regarding various entities (that is, AP MLD1, and affiliated AP1, affiliated AP2, and affiliated AP3 that can belong to the AP MLD1) on the access point side used for the pseudo multi-link transmission method. The information regarding the various entities on the access point side used for the pseudo multi-link transmission method specifically includes, for example, an identifier, a frequency band, capability information, and operation parameters.

The identifier includes, for example, a MAC address of a corresponding entity.

The frequency band includes information indicating a frequency band used by a corresponding entity. As the frequency band, for example, a 2.4 GHz band, a 5 GHz band, a 6 GHz band, a 45 GHz band, a 60 GHz band, or the like can be applied. Each frequency band includes a plurality of channels.

The capability information includes, for example, information indicating whether the corresponding entity is compatible with the multi-link transmission method.

The operation parameters include, for example, CWmin, CWmax, an arbitration interframe space (AIFS), and a transmission opportunity (TXOP) Limit. CWmin and CWmax indicate a minimum value and a maximum value of a contention window, respectively. The contention window is a parameter used to calculate backoff that is a transmission wait time for collision avoidance. AIFS is a fixed transmission wait time set for each traffic access category. The traffic access category includes, for example, “voice (VO)”, “video (VI)”, “best effort (BE)”, “background (BK)”, and “low latency (LL)”. TXOPLimit indicates an upper limit value of a channel occupancy period TXOP.

Note that the frequency band, the capability information, and the operation parameters related to the AP MLD1 may not be stored.

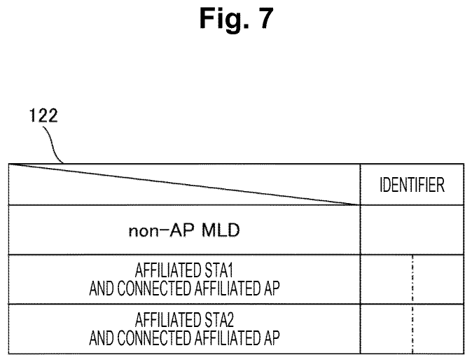

FIG. 7 is a table illustrating an example of a data structure of the terminal connection information stored in the sharing AP according to the embodiment.

As illustrated in FIG. 7, the terminal connection information 122 stores information regarding a connection status of the terminal 30 wirelessly connected to the sharing AP 10 by the pseudo multi-link transmission method. Specifically, for example, the terminal connection information 122 stores a set of an identifier of the non-AP MLD, an identifier of the affiliated STA1, and an identifier of the affiliated AP wirelessly connected to the affiliated STA1, and a set of an identifier of the affiliated STA2 and an identifier of the affiliated AP wirelessly connected to the affiliated STA2. Here, the identifier includes the MAC address of the target entity.

In the case of the connection example illustrated in FIG. 1, the affiliated AP wirelessly connected to the affiliated STA1 and the affiliated AP wirelessly connected to the affiliated STA2 are the affiliated AP1 and the affiliated AP2, respectively.

The functional configuration of the sharing AP 10 will be described with reference to FIG. 5 again.

Prior to the start of the pseudo multi-link transmission method, the upper MAC frame processing unit 130 inputs the multi-link management information 121 to the lower MAC frame processing unit 140 and the shared AP 20 via a wire.

When data is input from the lower MAC frame processing unit 140 and the shared AP 20, the upper MAC frame processing unit 130 performs processing such as deaggregation and then inputs the data to the LLC processing unit 110. Furthermore, when data is input from the LLC processing unit 110, the upper MAC frame processing unit 130 performs processing such as aggregation, and then distributes the data to any of (the lower MAC frame processing unit 140 of) the affiliated AP1 and the affiliated AP2 and the affiliated AP3 in the shared AP 20 via a wire. Note that upper MAC frame processing unit 130 may determine the distribution destination of the data by referring to the terminal connection information 122. In a case where a plurality of affiliated APs belongs to the AP MLD1, the upper MAC frame processing unit 130 may determine the distribution destination of the data according to a traffic identifier (TID) associated with an access category.

The lower MAC frame processing unit 140 generates a MAC frame by adding a MAC header to the data input from the upper MAC frame processing unit 130, and inputs the MAC frame to the wireless signal processing unit 150. Furthermore, the lower MAC frame processing unit 140 generates a beacon frame on the basis of the multi-link management information 121, and inputs the beacon frame to the wireless signal processing unit 150. The lower MAC frame processing unit 140 performs cyclic redundancy check (CRC) on the MAC frame input from the wireless signal processing unit 150, and executes error detection. Then, the lower MAC frame processing unit 140 inputs the data confirmed to have no error to the upper MAC frame processing unit 130.

The wireless signal processing unit 150 generates a wireless frame by adding a preamble or the like to the MAC frame and the beacon frame input from the lower MAC frame processing unit 140. The wireless signal processing unit 150 converts the generated wireless frame into a wireless signal. Then, the wireless signal processing unit 150 radiates (transmits) the converted wireless signal via an antenna. The conversion processing from the wireless frame to the wireless signal includes, for example, convolutional encoding processing, interleave processing, subcarrier modulation processing, inverse fast Fourier transform processing, orthogonal frequency division multiplexing (OFDM) modulation processing, and frequency conversion processing. Further, the wireless signal processing unit 150 converts the wireless signal from the terminal 30 received via the antenna into the wireless frame. The conversion processing from the wireless signal to the wireless frame includes, for example, frequency conversion processing, OFDM demodulation processing, fast Fourier transform processing, subcarrier demodulation processing, deinterleave processing, and Viterbi decoding processing. The wireless signal processing unit 150 extracts the MAC frame from the converted wireless frame. Then, the wireless signal processing unit 150 inputs the extracted MAC frame to the lower MAC frame processing unit 140.

### 1.1.3.2 Functional Configuration of Shared AP

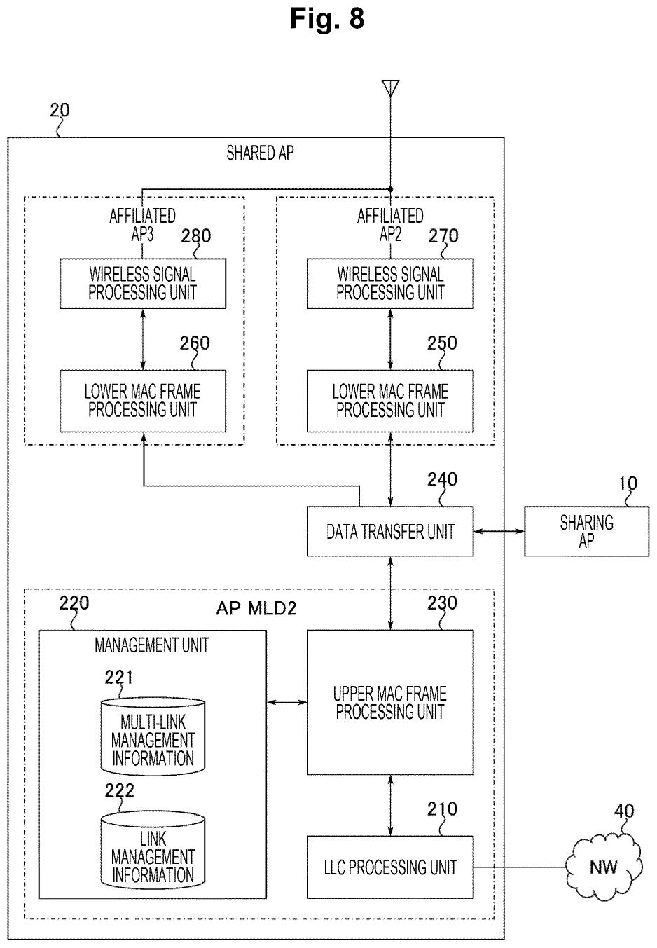

FIG. 8 is a block diagram illustrating an example of a functional configuration of the shared AP according to the embodiment.

The shared AP 20 functions as a computer including an LLC processing unit 210, a management unit 220, an upper MAC frame processing unit 230, a data transfer unit 240, lower MAC frame processing units 250 and 260, and wireless signal processing units 270 and 280. The LLC processing unit 210 is a functional block that executes processing corresponding to the LLC sublayer of the second layer and the third layer to the sixth layer. The management unit 220, the upper MAC frame processing unit 230, the data transfer unit 240, and the lower MAC frame processing units 250 and 260 are functional blocks that execute processing corresponding to the MAC sublayer of the second layer. The wireless signal processing units 270 and 280 are functional blocks that execute processing corresponding to the first layer. The LLC processing unit 210, the management unit 220, and the upper MAC frame processing unit 230 function as the AP MLD2. The lower MAC frame processing unit 250 and the wireless signal processing unit 270 function as the affiliated AP2. The lower MAC frame processing unit 260 and the wireless signal processing unit 280 function as the affiliated AP3.

The LLC processing unit 210 adds a DSAP header, an SSAP header, or the like to data received from the network 40, for example, and inputs the data to the upper MAC frame processing unit 230. Furthermore, the LLC processing unit 210 transmits data input from the upper MAC frame processing unit 230 to the network 40.

The management unit 220 controls logical wireless connection between the AP MLD2 and the non-AP MLD in a normal multi-link transmission method different from the pseudo multi-link transmission method (that is, a plurality of affiliated APs included in different access points is not used). For example, the management unit 220 executes connection processing by the normal transmission method in response to a request from the terminal 30. The management unit 220 stores multi-link management information 221.

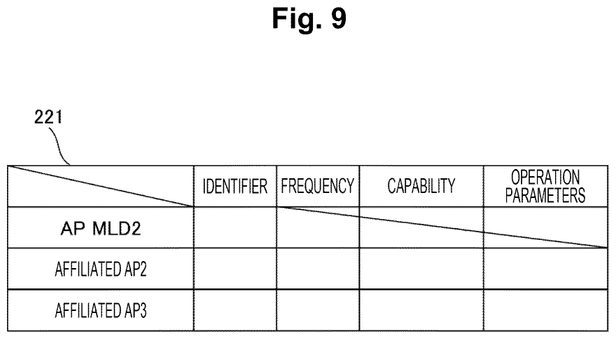

FIG. 9 is a table illustrating an example of a data structure of the multi-link management information stored in the shared AP according to the embodiment.

As illustrated in FIG. 9, information provided to the terminal 30 in a case where the normal multi-link transmission method is used is stored in the multi-link management information 221. Specifically, the multi-link management information 221 stores information regarding various entities (that is, AP MLD2, affiliated AP2, and affiliated AP3) on the access point side used for the normal multi-link transmission method. The information regarding the various entities on the access point side used for the normal transmission method specifically includes, for example, an identifier, a frequency band, capability information, and operation parameters.

The identifier, the frequency band, the capability information, and the operation parameters are equivalent to the identifier, the frequency band, and the operation parameters included in the multi-link management information 121. Note that the frequency band, the capability information, and the operation parameters related to the AP MLD2 may not be stored.

Further, the management unit 220 manages a physical wireless connection state between the affiliated AP2 in the shared AP 20 and the affiliated STA. Specifically, for example, the management unit 220 stores link management information 222. The management unit 220 may further store the multi-link management information 121.

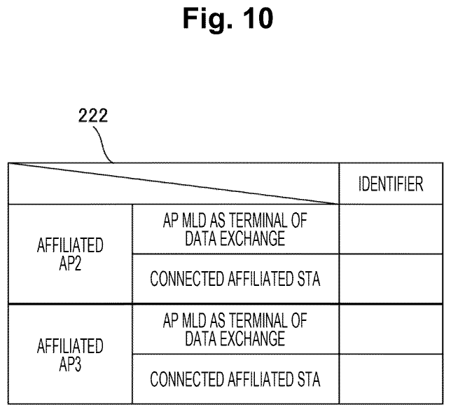

FIG. 10 is a table illustrating an example of a data structure of the link management information stored in the shared AP according to the embodiment.

As illustrated in FIG. 10, the link management information 222 stores, for each of the affiliated AP2 and the affiliated AP3 in the shared AP 20, an identifier for identifying an affiliated STA that is physically wirelessly connected. The identifier includes, for example, the MAC address of the affiliated STA. Furthermore, the link management information 222 stores an identifier for identifying an AP MLD that is a connection destination of the non-AP MLD to which the affiliated STA belongs (that is, AP MLD that serves as a terminal of data exchange in the wireless connection) for wireless connection between the affiliated AP and the affiliated STA.

In the case of the connection example according to the pseudo multi-link transmission method illustrated in FIG. 1, in the link management information 222, the MAC address of the AP MLD1 is stored as the AP MLD as a terminal of data exchange in an entry corresponding to the affiliated AP2, and the MAC address of the affiliated STA2 is stored as the connected affiliated STA. At this time, information regarding the pseudo multi-link transmission method is not stored in an entry corresponding to the affiliated AP3.

Note that, for example, in a case where the affiliated AP2 and the affiliated AP3 are connected to the affiliated STA1 and the affiliated STA2 by the normal multi-link transmission method, in the link management information 222, the MAC address of the AP MLD2 is stored as the AP MLD that is a terminal of data exchange in the entry corresponding to the affiliated AP2, and the MAC address of the affiliated STAL is stored as the connected affiliated STA. Furthermore, in the entry corresponding to the affiliated AP3, the MAC address of the AP MLD2 is stored as the AP MID as the terminal of data exchange, and the MAC address of the affiliated STA2 is stored as the connected affiliated STA.

The functional configuration of the shared AP 20 will be described with reference to FIG. 8 again.

Prior to start of the normal multi-link transmission method, the upper MAC frame processing unit 230 inputs the multi-link management information 221 to the lower MAC frame processing unit 250 in the affiliated AP2 and the lower MAC frame processing unit 260 in the affiliated AP3 via the data transfer unit 240.

When data is input from the lower MAC frame processing units 250 and 260 via the data transfer unit 240, the upper MAC frame processing unit 230 performs processing such as deaggregation and then inputs the data to the LLC processing unit 210. Furthermore, when data is input from the LLC processing unit 210, the upper MAC frame processing unit 230 performs processing such as aggregation and then inputs the data to the data transfer unit 240.

When data is input from the upper MAC frame processing unit 130 in the sharing AP 10 and the upper MAC frame processing unit 230 in the shared AP 20, the data transfer unit 240 distributes the data to the lower MAC frame processing units 250 and 260. Note that the data transfer unit 240 may determine the distribution destination of the data by referring to the link management information 222. In a case where a plurality of affiliated APs belongs to the AP MLD2, the data transfer unit 240 may determine the distribution destination of the data according to a TID associated with an access category.

Further, when data and information of the transmission source of a MAC frame are input from the lower MAC frame processing units 250 and 260, the data transfer unit 240 determines an AP MLD that is the terminal (that is, transmission destination) of data exchange with the transmission source with reference to the link management information 222 in the management unit 220. If the terminal of data exchange is the AP MLD1 as a result of the determination, the data transfer unit 240 transfers the MAC frame to the upper MAC frame processing unit 130 in the sharing AP 10. If the terminal of data exchange is the AP MLD2 as a result of the determination, the data transfer unit 240 transfers the MAC frame to the upper MAC frame processing unit 230 in the shared AP 20.

As described above, the configurations of the affiliated AP2 and the affiliated AP3 are equivalent to each other. Therefore, the configuration of the affiliated AP2 (that is, lower MAC frame processing unit 250 and wireless signal processing unit 270) will be mainly described below.

The lower MAC frame processing unit 250 generates a MAC frame by adding a MAC header to the data input from the upper MAC frame processing unit 230 or the data transfer unit 240, and inputs the MAC frame to the wireless signal processing unit 270. Further, when the multi-link management information 121 is input from the upper MAC frame processing unit 130, the lower MAC frame processing unit 250 generates a beacon frame regarding the pseudo multi-link transmission method on the basis of the multi-link management information 121, and inputs the beacon frame to the wireless signal processing unit 270. Similarly, when the multi-link management information 221 is input from the upper MAC frame processing unit 230, the lower MAC frame processing unit 250 generates a beacon frame regarding the normal multi-link transmission method on the basis of the multi-link management information 221, and inputs the beacon frame to the wireless signal processing unit 270. The lower MAC frame processing unit 250 performs CRC on the MAC frame input from the wireless signal processing unit 270, and executes error detection. Then, the lower MAC frame processing unit 250 inputs the data confirmed to have no error and the information of the transmission source of the MAC frame to the data transfer unit 240.

The wireless signal processing unit 270 generates a wireless frame by adding a preamble or the like to the MAC frame input from the lower MAC frame processing unit 250. The wireless signal processing unit 270 converts the generated wireless frame into a wireless signal. Then, the wireless signal processing unit 270 radiates (transmits) the converted wireless signal via an antenna. The conversion processing from the wireless frame to the wireless signal includes, for example, convolutional encoding processing, interleave processing, subcarrier modulation processing, inverse fast Fourier transform processing,, orthogonal frequency division multiplexing (OFDM) modulation processing, and frequency conversion processing. Further, the wireless signal processing unit 270 converts the wireless signal from the terminal 30 received via the antenna into the wireless frame. The conversion processing from the wireless signal to the wireless frame includes, for example, frequency conversion processing, OFDM demodulation processing, fast Fourier transform processing, subcarrier demodulation processing, deinterleave processing, and Viterbi decoding processing. The wireless signal processing unit 270 extracts the MAC frame from the converted wireless frame. Then, the wireless signal processing unit 270 inputs the extracted MAC frame to the lower MAC frame processing unit 250.

### 1.1.3.3 Functional Configuration of Terminal

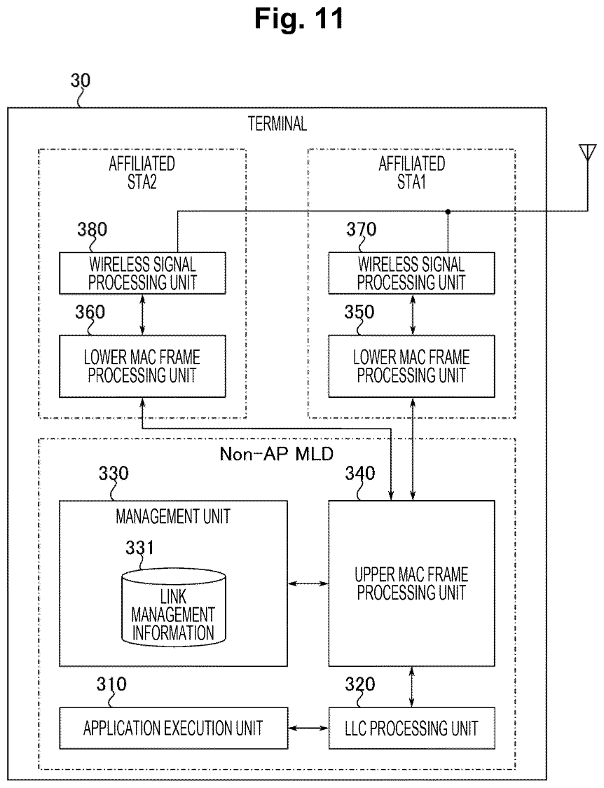

FIG. 11 is a block diagram illustrating an example of a functional configuration of the terminal according to the embodiment.

The terminal 30 functions as a computer including an application execution unit 310, an LLC processing unit 320, a management unit 330, an upper MAC frame processing unit 340, lower MAC frame processing units 350 and 360, and wireless signal processing units 370 and 380. The application execution unit 310 is a functional block that executes processing corresponding to the seventh layer. The LLC processing unit 320 is a functional block that executes processing corresponding to the LLC sublayer of the second layer and the third layer to the sixth layer. The management unit 330, the upper MAC frame processing unit 340, and the lower MAC frame processing units 350 and 360 are functional blocks that execute processing corresponding to the MAC sublayer of the second layer. The wireless signal processing units 370 and 380 are functional blocks that execute processing corresponding to the MAC sublayer of the second layer and the first layer. The application execution unit 310, the LLC processing unit 320, the management unit 330, and the upper MAC frame processing unit 340 function as the non-AP MLD. The lower MAC frame processing unit 350 and the wireless signal processing unit 370 function as the affiliated STA1. The lower MAC frame processing unit 360 and the wireless signal processing unit 380 function as the affiliated STA2.

The application execution unit 310 executes an application on the basis of data input from the LLC processing unit 320. Furthermore, the application execution unit 310 inputs data to the LLC processing unit 320. For example, the application execution unit 310 can display application information on the display 35. Further, the application execution unit 310 can operate on the basis of operation of an input interface.

The LLC processing unit 320 adds a DSAP header, an SSAP header, or the like to the data input from the application execution unit 310, and inputs the data to the upper MAC frame processing unit 340. Furthermore, the LLC processing unit 320 inputs the data input from the upper MAC frame processing unit 340 to the application execution unit 310.

The management unit 330 controls logical wireless connection between the AP MLD and the non-AP MLD. For example, the management unit 330 generates a multi-link connection request regarding the pseudo multi-link transmission method on the basis of the beacon frame generated on the basis of the multi-link management information 121. Furthermore, for example, the management unit 330 generates a multi-link connection request regarding the normal multi-link transmission method on the basis of the beacon frame generated on the basis of the multi-link management information 221. Note that the management unit 330 does not identify whether the generated multi-link connection request relates to the pseudo multi-link transmission method or the normal multi-link transmission method. Further, the management unit 330 stores link management information 331. The management unit 330 also stores information included in the beacon frame.

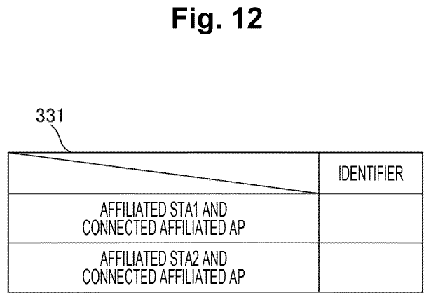

FIG. 12 is a table illustrating an example of a data structure of the link management information stored in the terminal according to the embodiment. FIG. 12 illustrates a data structure of the link management information 331 as an example of information stored in the terminal 30 in addition to the information included in the beacon frame.

As illustrated in FIG. 12, the link management information 331 stores identifiers for identifying the affiliated APs physically connected to the affiliated STA1 and the affiliated STA2 in the terminal 30. In the case of the connection example by the pseudo multi-link connection method illustrated in FIG. 1, the link management information 331 stores the MAC address of the affiliated AP1 connected to the affiliated STA1 and the MAC address of the affiliated AP2 connected to the affiliated STA2. Furthermore, in the case of the connection example by the normal multi-link connection method with the shared AP 20, the link management information 331 stores, for example, the MAC address of the affiliated AP2 connected to the affiliated STA1 and the MAC address of the affiliated AP3 connected to the affiliated STA2.

The functional configuration of the terminal 30 will be described with reference to FIG. 11 again.

When data is input from the lower MAC frame processing units 350 and 360, the upper MAC frame processing unit 340 performs processing such as deaggregation and then inputs the data to the LLC processing unit 320. Furthermore, when data is input from the LLC processing unit 320, the upper MAC frame processing unit 340 performs processing such as aggregation and then distributes the data to any of the lower MAC frame processing units 350 and 360 via a wire. Note that the upper MAC frame processing unit 340 may determine the distribution destination of the MAC frame according to the TID.

As described above, the configurations of the affiliated STA1 and the affiliated STA2 are equivalent to each other. Therefore, the configuration of the affiliated STA1 (that is, lower MAC frame processing unit 350 and wireless signal processing unit 370) will be mainly described below.

The lower MAC frame processing unit 350 generates a MAC frame by adding a MAC header to the data input from the upper MAC frame processing unit 340. Then, the lower MAC frame processing unit 350 inputs the generated MAC frame to the wireless signal processing unit 370. The lower MAC frame processing unit 350 performs CRC on the MAC frame input from the wireless signal processing unit 370, and executes error detection. Then, the lower MAC frame processing unit 350 inputs the data confirmed to have no error to the upper MAC frame processing unit 340.

The wireless signal processing unit 370 generates a wireless frame by adding a preamble or the like to the MAC frame input from the lower MAC frame processing unit 350. The wireless signal processing unit 370 converts the generated wireless frame into a wireless signal. Then, the wireless signal processing unit 370 radiates (transmits) the converted wireless signal via an antenna. The conversion processing from the wireless frame to the wireless signal includes, for example, convolutional encoding processing, interleave processing, subcarrier modulation processing, inverse fast Fourier transform processing, OFDM modulation processing, and frequency conversion processing. Furthermore, the wireless signal processing unit 370 converts the wireless signal from the corresponding shared AP 20 received via an antenna into the wireless frame. The conversion processing from the Wireless signal to the wireless frame includes, for example, frequency conversion processing, OFDM demodulation processing, fast Fourier transform processing, subcarrier demodulation processing, deinterleave processing, and Viterbi decoding processing. The wireless signal processing unit 370 extracts the MAC frame from the converted wireless frame. Then, the wireless signal processing unit 370 inputs the extracted MAC frame to the lower MAC frame processing unit 350.

### 1.2 Operation

Next, the operation in the communication system according to the embodiment will be described.

### 1.2.1 Pseudo Multi-Link Connection Processing

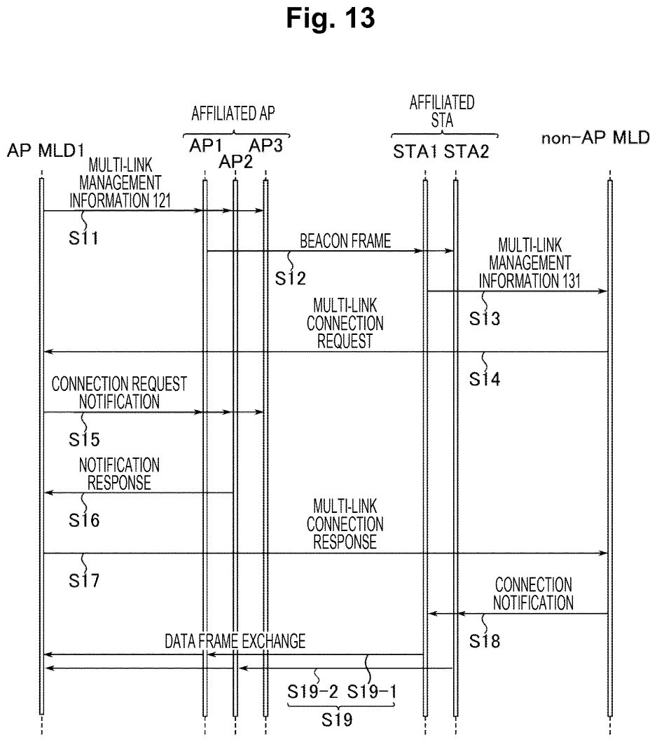

FIG. 13 is a sequence diagram illustrating an example of a series of processing including the pseudo multi-link connection processing in the communication system according to the embodiment. FIG. 13 illustrates a flow of information exchanged among the AP MLD1, the affiliated AP1, the affiliated AP2, the affiliated AP3, the affiliated STA1, the affiliated STA2, and the non-AP MLD in a series of processing including the pseudo multi-link connection processing.

The AP MLD1 inputs the multi-link management information 121 to each of the affiliated AP1, the affiliated AP2, and the affiliated AP3 via a wire (S11).

Each of the affiliated AP1, the affiliated AP2, and the affiliated AP3 generates a beacon frame regarding the pseudo multi-link transmission method on the basis of the multi-link management information 121 input in the processing of S11. Then, each of the affiliated AP1, the affiliated AP2, and the affiliated AP3 reports the generated beacon frame to the affiliated STA1 and the affiliated STA2 (S12).

Each of the affiliated STA1 and the affiliated STA2 receives the beacon frame reported in the processing of S12. Then, each of the affiliated STAI and the affiliated STA2 inputs the multi-link management information 121 included in the beacon frame to the non-AP MLD (S13).

The non-AP MLD generates a multi-link connection request on the basis of information in the beacon frame input in processing of S13, and transmits the multi-link connection request using the MAC address of the AP MLD1 as the destination (S14). The multi-link connection request includes, for example, information regarding an affiliated AP to which each of the affiliated STA1 and the affiliated STA2 desires connection at the start of multi-link. The multi-link connection request is transmitted to the AP MLD1 via at least one affiliated STA of the affiliated STA1 or the affiliated STA2 and at least one affiliated AP of the affiliated AP1, the affiliated AP2, or the affiliated AP3.

The AP MLD1 determines an affiliated AP that establishes a wireless link with each of the affiliated STA1 and the affiliated STA2 on the basis of the multi-link connection request transmitted in the processing of S14. Then, the AP MLD1 transmits a connection request notification to the affiliated AP1, the affiliated AP2, and the affiliated AP3 via a wire (S15). The connection request notification includes information for notifying which affiliated AP and which affiliated STA exchange data with each other in a wireless link established between the AP MLD1 and the non-AP MLD. The connection request notification may include information equivalent to the multi-link connection request transmitted in the processing of S14.

The affiliated AP determines whether the affiliated AP has been selected as an affiliated AP that establishes a wireless link with the affiliated STA with reference to the connection request notification. The affiliated AP notified to establish a wireless link with the affiliated STA generates a notification response and transmits the notification response to the AP MLD1 via the wire (S16).

Upon receiving the notification response from all affiliated APs that establish a wireless link with the affiliated STA, the AP MLD1 generates a multi-link connection response, and transmits the multi-link connection response using the MAC address of the non-AP MLD as the destination (S17). The multi-link connection response is transmitted to the non-AP MLD via at least one affiliated AP of the affiliated AP1, the affiliated AP2, or the affiliated AP3 and at least one affiliated STA of the affiliated STAI or the affiliated STA2.

The non-AP MLD generates a connection notification on the basis of the multi-link connection response transmitted in the processing of S17. Then, the non-AP MLD inputs the generated connection notification to each of the affiliated STAL and the affiliated STA2 (S18).

Thus, the pseudo multi-link connection processing between the AP MLD1 and the non-AP MLD is completed. After the pseudo multi-link connection processing is completed, data exchange using a wireless link between the affiliated AP1 and the affiliated STAL and a wireless link between the affiliated AP2 and the affiliated STA2 in combination is executed between the AP MLD1 and the non-AP MLD (S19).

Specifically, the affiliated AP1 that has received the data from the affiliated STAL inputs the data to the AP MLD1 that is the AP MLD in the same access point (sharing AP 10) (S19-1). Furthermore, the affiliated AP2 that has received the data from the affiliated STA2 inputs the MAC address of the affiliated STA2 to the data transfer unit 240 together with the data as information of the transmission source. The data transfer unit 240 determines that the AP MLD as a terminal of the data exchange via the affiliated STA2 is the AP MLD1 with reference to the link management information 222. Then, the data transfer unit 240 transfers the received data to the AP MLD1 (S19-2).

Note that, although not illustrated in FIG. 13, in a case where the affiliated AP2 and the affiliated AP3 establish wireless links with the affiliated STA1 and the affiliated STA2, respectively, to execute the normal multi-link transmission method, the data transfer unit 240 transfers the received data to the AP MLD2. By operation being performed in this manner, the data is distributed to the AP MLD of the transmission destination.

### 1.3 Effects According to Embodiment

According to the embodiment, the AP MLD1 transmits the multi-link management information 131 to each of the affiliated AP1, the affiliated AP2, and the affiliated AP3. Each of the affiliated AP1, the affiliated AP2, and the affiliated AP3 reports the beacon frame to the non-AP MLD on the basis of the multi-link management information 131. The beacon frame includes information including an identifier of the AP MLD1, identifiers of all affiliated APs that belong to the AP MLD1 and are compatible with the pseudo multi-link transmission method, frequencies, operation parameters, and the like. As a result, the non-AP MLD can recognize the AP MLD1 and the affiliated AP1 included in the sharing AP 10 and the affiliated AP2 included in the shared AP 20 as one pseudo access point. For this reason, the non-AP MLD can transmit a multi-link connection request regarding the pseudo multi-link transmission method in which the wireless link between the affiliated STA1 and the affiliated AP1 and the wireless link between the affiliated STA2 and the affiliated AP2 are used in combination using the AP MLD1 as the destination using the scheme of the normal multi-link transmission method on the basis of the beacon frame. Accordingly, the AP MLD1 and the non-AP MLD can establish the pseudo multi-link transmission method in which the wireless link between the affiliated AP1 and the affiliated STA1 and the wireless link between the affiliated STA2 and the affiliated AP2 are used in combination.

Furthermore, the data transfer unit 240 determines an AP MLD that is a terminal of data exchange with the transmission source on the basis of the link management information 222 and the MAC address of the transmission source of the received data. Accordingly, the data transfer unit 240 can transfer the received data to the AP MLD1 if the terminal of the data exchange is the AP MLD1 in the sharing AP 10, and can transfer the received data to the AP MLD1 if the terminal of the data exchange is the AP MLD2 in the shared AP 20. For this reason, the shared AP 20 can function as an access point for data transfer in the pseudo multi-link transmission method and also as an access point as the terminal of data exchange in the normal multi-link transmission method.

### 2. Modifications and Like

Note that various modifications can be applied to the above-described embodiment.

In the above-described embodiment, a case where the sharing AP 10 includes one affiliated AP has been described, but the present invention is not limited thereto. For example, the sharing AP 10 may include a plurality of affiliated APs.

Further, in the above-described embodiment, a case where the sharing AP 10 and the shared AP 20 are included apart from each other has been described, but the present invention is not limited thereto. For example, the sharing AP 10 and the shared AP 20 are not necessarily included apart from each other.

Furthermore, in the above-described embodiment, the sharing AP 10 and the shared AP 20 include different configurations regarding whether to include the data transfer unit 240, but the present invention is not limited thereto. For example, the sharing AP 10 may include a data transfer unit similarly to the shared AP 20. In this case, both the sharing AP 10 and the shared AP 20 can function as both a sharing access point and a shared access point.

Further, the pseudo multi-link connection processing in the sharing AP 10, the shared AP 20, and the terminal 30 according to the above-described embodiment can be stored as a program that can be executed by a processor that is a Computer. Further, the program can be stored in a storage medium of an external storage device such as a magnetic disk, an optical disc, or a semiconductor memory for distribution. Then, the processor of each of the sharing AP 10, the shared AP 20, and the terminal 30 reads the program stored in the storage medium of the external storage device, and the operation is controlled by the read program, whereby the pseudo multi-link connection processing can be executed.

Note that the present invention is not limited to the embodiments described above and can variously be modified at an execution stage within a scope not departing from the gist of the present invention. In addition, the embodiments may be implemented in appropriate combination, and in that case, a combined effect can be obtained. The embodiments described above include various inventions, and various inventions can be extracted according to the combination selected from a plurality of disclosed components. For example, even if some components are deleted from all the components described in the embodiments, a configuration from which the components have been deleted can be extracted as an invention, as long as the problem can be solved and the effects can be achieved.

### REFERENCE SIGNS LIST

1 Communication system
10 Sharing AP
20 Shared AP
30 Terminal
40 Network
11, 21, 31 CPU
12, 22, 32 ROM
13, 23, 33 RAM
14, 24, 34 Wireless communication module
15, 16, 25, 26 Wired communication module
35 Display
36 Storage
110, 210, 320 LLC processing unit
120, 220, 330 Management unit
130, 230, 340 Upper MAC frame processing unit
140, 250, 260, 350, 360 Lower MAC frame processing unit
150, 270, 280, 370, 380 Wireless signal processing unit
240 Data transfer unit
310 Application execution unit
121, 221 Multi-link management information
122 Terminal connection information
222, 331 Link management information

1. A sharing access point in a communication system including a sharing access point and a shared access point, the sharing access point comprising:
first management circuitry; and
first wireless signal processing circuitry,
wherein:
the shared access point includes second management circuitry and second wireless signal processing circuitry, and
the first management circuitry:
generates first information regarding a plurality of wireless signal processing circuitries including the second wireless signal processing circuitry, and
causes at least one of the first wireless signal processing circuitry or the second wireless signal processing circuitry to report the first information.

2. The sharing access point according to claim 1, wherein:
the first information includes information indicating that the second wireless signal processing circuitry belongs to the first management circuitry.

3. The sharing access point according to claim 1, wherein:
the first management circuitry establishes a pseudo multi-link using a plurality of wireless links using the plurality of wireless signal processing circuitries in combination with a terminal device.

4. A shared access point in a communication system including a shared access point and a shared access point, wherein:
the sharing access point includes a first management circuitry and a first wireless signal processing circuitry,
the shared access point includes a second management circuitry, a second wireless signal processing circuitry, and a transfer circuitry,
the second management circuitry receives, from the first management circuitry, first information indicating that each of a plurality of wireless signal processing circuitries belongs to the first management circuitry, the first information being regarding the plurality of wireless signal processing circuitries including the second wireless signal processing circuitry, and
the transfer circuitry determines whether to transfer data to the first management circuitry or the second management circuitry on a basis of the first information and second information indicating a transmission source of the data received via the second wireless signal processing circuitry.

5. The shared access point according to claim 4, wherein:
the second information includes a MAC address of a terminal device as the transmission source.

6. The shared access point according to claim 4, wherein:
the first management circuitry establishes a pseudo multi-link using a plurality of wireless links using a plurality of wireless signal processing circuitries including the second wireless signal processing circuitry in combination with a terminal device.

7. A communication method of a sharing access point in a communication system including a sharing access point including a first management circuitry and a first wireless signal processing circuitry and a shared access point including a second management circuitry and a second wireless processing circuitry, the communication method comprising:
generating first information regarding a plurality of wireless signal processing circuitries including the second wireless signal processing circuitry; and
causing at least one of the first wireless signal processing circuitry or the second wireless signal processing circuitry to report the first information.

8. (canceled)
